(19) United States
(12) Patent Application Publication
(10) Pub. No.: US 2003/0065696 A1
(43) Pub. Date: Apr. 3, 2003

(54) Method and apparatus for performing modular exponentiation

(76) Inventors: Michael D. Ruehle, Santa Clara, CA (US); John A. Morelli, Milpitas, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/966,224

(22) Filed: Sep. 28, 2001

(51) Int. Cl. G06F 7/38

(52) U.S. Cl. 708/491

(57) ABSTRACT

A method and apparatus for performing modular exponentiation is disclosed. An apparatus in accordance with one embodiment of the present invention includes a first modular exponentiator and a second modular exponentiator and a coupling device interposed between the first modular exponentiator and the second modular exponentiator to receive a control signal and to selectively couple the first modular exponentiator to the second modular exponentiator in response to a state of the control signal. In one embodiment, the apparatus has a first mode of operation corresponding to a first state of the control signal wherein the first modular exponentiator is operably separated from the second modular exponentiator and a second mode of operation corresponding to a second state of the control signal wherein the first modular exponentiator is operably coupled to the second modular exponentiator via the coupling device.

### BACKGROUND OF THE INVENTION

1. Field of the Invention

The present invention relates generally to the fields of arithmetic processing and cryptography. More particularly, the present invention relates to a method and apparatus of performing modular exponentiation.

2. Description of the Related Art

Modular exponentiation and related mathematical operations are commonly used in a number of applications such as cryptography. For example, modular exponentiation of the form X^{E} mod M is the primary operation involved in the Rivest-Shamir-Adleman (RSA) cryptographic system where X, E, and M are all large (e.g. 512 or 1024-bit) unsigned integers. Modular exponentiation, in turn, is a process of repeated modular multiplication of the form A×B mod M utilizing similarly-sized integers. One way to perform modular multiplication is to compute A×B first and then reduce the resulting product modulo M. The time and resources necessary to perform these two separate operations and to detect the resulting remainder makes this technique undesirable for large integer numbers. Modular multiplication may also be performed utilizing another technique known as “Montgomery multiplication” in which the multiplication and modular reductions operations are performed in a single step within a mathematical transform space.

Conventional modular multipliers often include a systolic array or “chain” of processing elements implemented in hardware such as an application-specific integrated circuit (ASIC) or a programmable logic device such a field programmable gate array (FPGA) where each processing element performs a portion of the modular multiplication operation. In such multipliers, the total number of processing elements required is related both to the size of the modular multiplication operands and the number of bits processed per element. For example, a 512-bit modular multiplication operation would require at least 128 4-bit processing elements whereas a 1024-bit modular multiplication operation would require at least 256. Modular multipliers typically also include a fixed number of additional processing elements and/or additional logic to accurately perform modular multiplication operations.

For purposes of Secure Socket Layer (SSL) and RSA cryptography, conventional modular multipliers are utilized primarily with 512-bit operands to perform modular exponentiation operations such as those involved in 1024-bit RSA private-key operations (decryptions). Modem cryptographic systems such as RSA however also utilize modular multipliers with 1024-bit operands to perform for example, 1024-bit RSA public key operations (encryptions) or 2048-bit RSA private key operations. One technique allowing modular multiplication to be performed on operands having various sizes (e.g. both 512-bit and 1024-bit operands) is to provide a modular exponentiator including a separate modular multiplier for each operand size. This technique is undesirable however because it lacks flexibility and requires hardware resources to be dedicated for infrequently performed operations. It is also possible to perform modular computations utilizing a modular multiplier having more than the requisite number of processing elements. For example, a 1024-bit modular multiplier can be utilized to perform 512-bit modular exponentiation operations. This technique also requires the addition of inefficient hardware resources and lowers the speed with which the smaller-sized operations can be performed (i.e. a 512-bit operation takes twice as long to perform on a 1024-bit modular multiplier as it does on a 512-bit modular multiplier).

### BRIEF DESCRIPTION OF THE DRAWINGS

The present invention is illustrated by way of example and not limitation in the figures of the accompanying drawings in which similar references are utilized to indicate similar elements and in which:

FIG. 1 illustrates a communications network according to one embodiment of the present invention;

FIG. 2 illustrates an exemplary data processing system block diagram according to one embodiment of the present invention;

FIG. 3 illustrates a high-level block diagram of a modular exponentiator according to a first embodiment of the present invention;

FIG. 4 illustrates a high-level block diagram of an exponentiation controller according to one embodiment of the present invention.

FIG. 5 illustrates a high-level block diagram of a field programmable gate array (FPGA) structure according to an embodiment of the present invention; and

FIG. 6 illustrates a high-level process flow diagram for one embodiment of the present invention.

### DETAILED DESCRIPTION

A method and apparatus for performing modular exponentiation are described herein. In the following detailed description, numerous specific details such as specific computer system, modular exponentiator, and modular multiplier, and exponentiation controller architectures or structures are set forth in order to provide a more thorough understanding of the present invention. It should be evident however, that these and other specific details described need not be utilized to practice the present invention. In other circumstances, well-known structures, elements, or connections have been omitted, or have not been described in particular detail in order to avoid unnecessarily obscuring the present invention.

Similarly, various portions of the description of the present invention refer to parts of the invention utilizing the terms ‘right’, ‘left’, ‘right-hand’, ‘left-hand’, ‘right-most’, or ‘left-most’. These terms refer to relative orientation as shown in the figures, and should not be interpreted as limitations on the physical implementation of the invention.

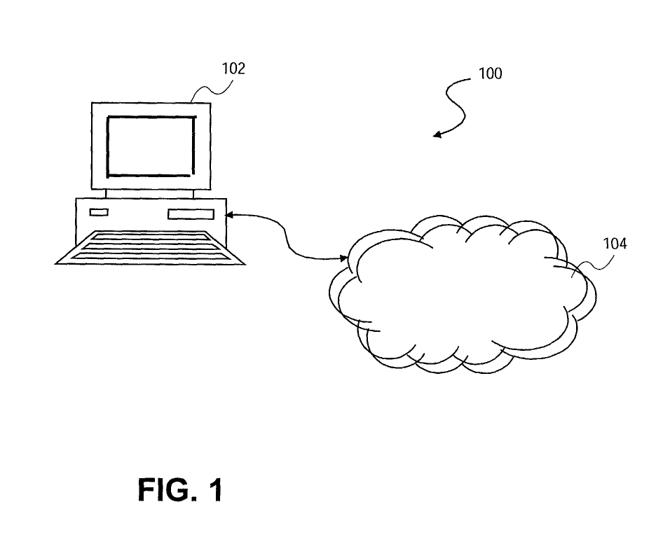

FIG. 1 illustrates a communications network 100 according to one embodiment of the present invention. In the illustrated embodiment, a data processing system 102 including a processor according to an embodiment of the present invention is coupled to and communicates with one or more devices or data processing systems (not illustrated) via a communications channel 104. In one embodiment, encrypted data or “ciphertext” is received by data processing system 102 via communications channel 104 and processed or “decrypted” according to the present invention. In another embodiment of the present invention, “plaintext” or other data is processed or “encrypted” by data processing system 102 according to the present invention and then transmitted across communications network 100 via communication channel 104.

In alternative embodiments of the present invention, communications network 100 may be organized as either a wide area network (WAN) covering a large geographic area or a local area network (LAN) encompassing by comparison, a smaller physical region. Network 100 may include conventional network backbones, long-haul telephone lines, Internet service providers, various bridges, gateways, routers, and other conventional means for routing data between data processing systems. Communications network 100 may be private, for use by members of a particular company or organization, in which case the network is described as an intranet, or public, as for example, a portion of the Internet such as the World Wide Web (WWW). In one embodiment, communications network 100 comprises a WAN such as the WWW portion of the Internet, or a proprietary network such as America Online™, Compuserve™, Microsoft Network™, and/or Prodigy™.

Data received or transmitted by data processing system 102 may be encrypted, decrypted, authenticated, or otherwise processed according to the present invention using a variety of techniques which utilize modular multiplication or exponentiation. These techniques or “cryptosystems” may be either symmetric or asymmetric. Symmetric cryptosystems, also known as “private key” systems, utilize a single, secret key shared between the sender and receiver of the encrypted data to encrypt and decrypt or authenticate. In an asymmetric or “public key” cryptosystem by contrast, two keys are utilized. A first “public key” is provided to the sender and used to encrypt data prior to transmission. A second “private key” is then used to decrypt or authenticate data encrypted using the public key. Unlike the public key, which is typically made publicly available, the private key is secret and is optimally known only to the data receiver.

Private and public keys in asymmetric cryptosystems are mathematically linked in such a way as to make encryption/decryption/authentication processing operations possible while making it difficult to derive a private key given a corresponding public key. In one embodiment of the present invention the RSA public-key cryptosystem is utilized. In the RSA system, the private key consists of a modulus M and a private exponent D where M is equal to the product of two large (e.g. 256-bit or larger) random prime numbers p and q, and D is a large (e.g. greater than the maximum of p and q) random integer which is relatively prime to (p−1)(q−1), meaning that the greatest common divisor of D and (p−1)(q−1) is 1. The public key of the RSA cryptosystem consists of the modulus M and a public exponent E, where E is the multiplicative inverse of D modulo (p−1)(q−1). In one embodiment, a public exponent E is selected first and the private exponent D is computed as its multiplicative inverse modulo (p−1)(q−1).

The primary operation involved in encryption and decryption or authentication under the RSA cryptosystem is modular exponentiation which can in turn be broken down into repeated modular multiplication of the form A×B mod M, where A, B, and M are all integers. Data is encrypted under the RSA system by first representing it as an integer between 0 and M−1 and then raising that integer to the E^{th} power modulo M. That is, given numerically represented plaintext P, ciphertext C is generated such that C=P^{E} mod M. Conversely, encrypted data is decrypted under RSA by raising it to the D^{th} power modulo M. That is, given ciphertext C encrypted using a public key (E, M) as described, numerically represented plaintext P is generated using an associated private key (D, M) according to the formula P=C^{D} mod M.

In alternative embodiments of the present invention, other techniques utilizing modular multiplication or modular exponentiation such as the Digital Signature Algorithm (DSA), Diffie-Hellman Key Exchange, Pohlig-Hellman, Rabin, ElGamal, Blum-Blum-Shub, and Elliptic Curve cryptosystems are implemented.

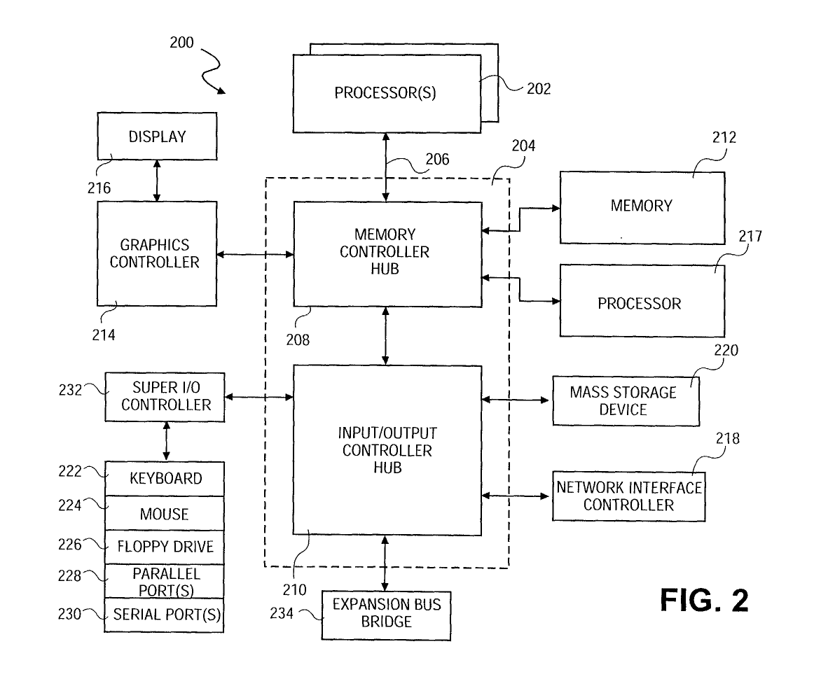

FIG. 2 illustrates, in block diagram form, an exemplary data processing system 200 such as data processing system 102 of FIG. 1 according to one embodiment of the present invention. In the illustrated embodiment, data processing system 200 comprises one or more processors 202 and a chipset 204 coupled to a processor system bus 206. Processor(s) 202 may each comprise any suitable processor architecture and for one embodiment comprise an Intel™ Architecture, used for example, in the Pentium™ family of processors available from Intel™ Corporation of Santa Clara, Calif. Chipset 204 for one embodiment of the present invention comprises a “north bridge” or memory controller hub (MCH) 208 and a “south bridge” or input/output (I/O) controller hub (ICH) 210 coupled together as shown. MCH 208 and ICH 210 may each comprise any suitable circuitry and for one embodiment, are each formed as a separate integrated circuit chip. Chipset 204 for other embodiments may comprise any suitable one or more integrated circuit or discrete devices.

MCH 208 may comprise a suitable interface controller to provide for any suitable communication link to processor system bus 206 and/or to any suitable device or component in communication with MCH 208. MCH 208 for one embodiment provides suitable arbitration, buffering, and coherency management for each interface.

MCH 208 is coupled to processor system bus 206 and provides an interface to processor(s) 202 over the processor system bus 206. Processor(s) 202 may, in alternative embodiments of the present invention be combined with MCH 208 or chipset 204 to form a single chip. MCH 208 in one embodiment also provides an interface to a memory 212, a graphics controller 214, and a processor 217 according to the present invention, each of which is coupled to MCH 208 as illustrated. Memory 212 is capable of storing data and/or instructions executable on a processor such as processor 202 or 217 of data processing system 200 and may comprise any suitable memory such as dynamic random access memory (DRAM) for example. Graphics controller 214 controls the display of information on a suitable display 216, such as a cathode ray tube (CRT) or liquid crystal display (LCD) for example, coupled to graphics controller 214. In the illustrated embodiment, MCH 208 interfaces with graphics controller 214 through an accelerated graphics port. However, it will be appreciated that the present invention may be practiced using any suitable graphics bus or port standard. Graphics controller 214 for one embodiment may alternatively be combined with MCH 208 to form a single chip.

Although processor 217 has been depicted as an independent, special-purpose or “application specific” integrated circuit chip in the described figure, in alternative embodiments of the present invention processor 217 is implemented as a programmable logic or gate array device such as a field programmable gate array (FPGA) and as a general purpose processor (e.g., one or more of processor(s) 212) programmed utilizing executable instructions embodied within a machine-readable medium to cause the general purpose processor to perform methods of the present invention.

Processor 217 is utilized, according to one embodiment of the invention, to accelerate computationally intensive tasks such as modular exponentiation and/or modular multiplication associated with encryption, decryption or authentication operations of cryptosystems such as RSA. Accordingly, in one embodiment processor 217 includes at least a first and second modular exponentiator and a coupling device interposed between the first and second modular exponentiators to selectively couple the first and second modular exponentiators together in response to the state of a received control signal to operate as two n-bit modular exponentiators in a first, operably separated mode of operation and as a single 2 n-bit modular exponentiator in a second, operably coupled mode of operation. In alternative embodiments of the invention, processor 217 can be coupled to data processing system 200 via a well-known processor socket (not illustrated), via a dual inline memory module (DIMM) slot on a PC-100 or PC-133 memory bus coupled to MCH 208, or via an expansion bus further described herein.

MCH 208 is also coupled to ICH 210 to provide access to ICH 210 through a hub interface. ICH 210 provides an interface to I/O devices or peripheral components for data processing system 200. ICH 210 may comprise any suitable interface controller to provide for any suitable communication link to MCH 208 and/or to any suitable device or component in communication with ICH 210. ICH 210 for one embodiment provides suitable buffering and arbitration for each interface.

In the illustrated embodiment, ICH 210 further provides an interface to a network interface controller 218, a mass store device 220, and to a keyboard 222, a mouse 224, a floppy disk drive 226, as well as additional devices via one or more standard parallel 228 or serial 230 ports through a super I/O controller 232. Network interface controller 218 or alternatively a modem codec (not illustrated) may be utilized to couple data processing system 200 to a suitable communications network such as communications network 100 of FIG. 1 via various well-known methods. Mass store device 220 may comprise any suitable device or component to store data and/or instructions such as a tape or fixed disk magnetic storage device, or an optical storage device such as a compact disk (CD) or digital versatile disk (DVD) read only memory (ROM) device. In one embodiment of the present invention, mass store device 220 comprises one or more hard disk drives (HDD). In the illustrated embodiment, ICH 210 also provides an interface to an expansion bus bridge 234 to facilitate the attachment of additional I/O devices or peripheral components via an expansion bus such as a Peripheral Component Interconnect (PCI), Industry Standard Architecture (ISA), or Universal Serial (USB) bus (not illustrated).

Embodiments of the present invention may include software, information processing hardware, and various processing operations, further described herein. The features and process operations of the present invention may be embodied in executable instructions embodied within a machine-readable medium such as memory 212, mass store device 220, removable disk media coupled with floppy disk drive 226, a communications network available via network interface controller 218, or the like.

A machine-readable medium may include any mechanism that provides (i.e., stores and/or transmits) information in a form readable by a machine (e.g., data processing system 200). For example, a machine-readable medium includes but is not limited to: read only memory (ROM); random access memory (RAM); magnetic disk storage media; optical storage media; flash memory devices; electrical, optical, acoustical or other form of propagated signals (e.g., carrier waves, infrared signals, digital signals, etc.); or the like. The instructions can be used to cause a general or special purpose processor such as processor 202 or processor 217, programmed with the instructions, to perform methods or processes of the present invention. Alternatively, the features or operations of the present invention may be performed by specific hardware components that contain hard-wired logic for performing the operations, or by any combination of programmed data processing components and custom hardware components.

It should be appreciated that the present invention may be practiced utilizing a data processing system 200 having a greater or lesser number of components as the illustrated exemplary system. For example, data processing system 200 may comprise, in alternative embodiments of the present invention, one of a wide variety of server or client computer systems or devices such as a workstation, personal computer, “thin client” (i.e. network computer or NetPC), Internet appliance, terminal, palmtop computing device, robust cellular or Personal Communications Services (PCS) telephone, “thin server” (sometimes called an appliance server, application server, or specialty server), or the like. In one embodiment of the present invention data processing system 200 comprises a server computer system. In another embodiment of the present invention data processing system 200 comprises an electronic commerce accelerator network appliance for performing Secure Socket Layer (SSL) connections or encryption/decryption operations.

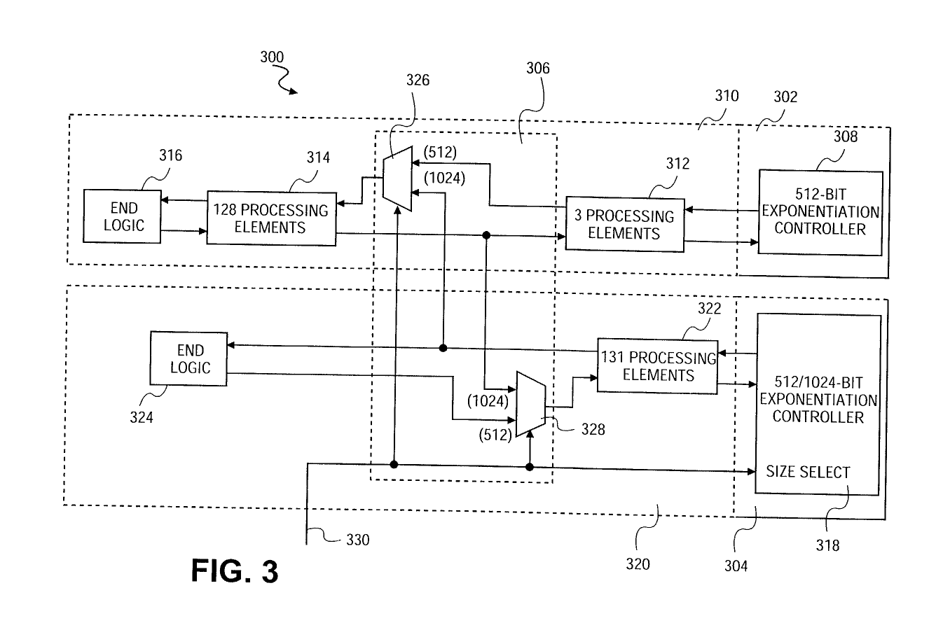

FIG. 3 illustrates a high-level block diagram of a modular exponentiator 300 according to one embodiment of the present invention. Modular exponentiator 300 of the illustrated embodiment includes a first modular exponentiator 302 and a second modular exponentiator 304 selectively coupled together via a coupling device 306 according to the present invention. First modular exponentiator 302 includes a first exponentiation controller (EC) 308 and a first modular multiplier 310 made up of a first group of processing elements (PEs) 312, a second group of processing elements 314, and terminating or “end” logic 316. Similarly, second modular exponentiator 304 includes a second exponentiation controller 318 and a second modular multiplier 320 made up of a group of processing elements 322, and end logic 324. Coupling device 306 includes a first multiplexer 326 and a second multiplexer 328 to selectively couple the first modular exponentiator 302 and the second modular exponentiator together as illustrated.

While a wide variety of techniques and hardware implementations may be used to implement modular multiplication, first modular multiplier 310 and second modular multiplier 320 of the illustrated embodiment each comprise a Montgomery multiplier constructed as a linear systolic array of processing elements with each processing element processing some number of bits of a Montgomery multiplication operation. For example, each processing element in the embodiment depicted in FIG. 3 operates on 4 bits of a Montgomery multiplication operation at a time. The number of processing elements utilized in this embodiment is equal to the number of bits in the Montgomery multiplication arguments divided by the number of bits per processing element plus four. For example, a 512-bit Montgomery multiplication would require 132 4-bit processing elements and a 1024-bit Montgomery multiplication would require 259 4-bit processing elements. However, the final or “leftmost” processing element is typically only utilized to handle overflow conditions and is therefore incorporated into the end logic of its respective processing chain with the number of fully-implemented processing elements being reduced by one (e.g. 131 4-bit processing elements for a 512-bit Montgomery multiplication).

In the illustrated embodiment, the processing elements or “PEs” are arranged and coupled together in a linear systolic array or “chain” and coupled to a clock source (not illustrated). For purposes of this description, the processing elements of a given array or chain will be referred to by number from zero to the total number of processing elements in the chain minus one (e.g. PE-0 to PE-130 for a 512-bit Montgomery multiplication chain) starting with the first or “rightmost” processing element coupled to the chain's exponentiation controller. Input data as well as control signals are received via PE-0 and propagated or pumped through the multiplication chain. During processing, a given PE receives data from and provides data to both of its immediate (i.e. previous/right and next/left) neighboring processing elements in the linear systolic array on each “clock” or pulse of the clock source. Appropriate inputs are therefore provided to the first or “rightmost” processing element (e.g. PE-0) via an associated exponentiation controller and to the final or “leftmost” processing element in each linear systolic array (e.g. PE-130 in a 512 bit Montgomery multiplier) via end or “terminating” logic.

In alternative embodiments of the present invention, a greater or lesser number of processing elements may be utilized and one or more ground terminations may be used as end logic to provide logical zeros to the last processing element of each Montgomery multiplication chain. The end logic (i.e. 316 and 324) of the illustrated embodiment however includes a final processing element and more sophisticated logic to provide appropriate inputs to the remainder of an associated Montgomery multiplication chain. For example, in one embodiment of the present invention, end logic 316 and 324 includes an “OR” logic gate to receive at least two carry bits from the next to last processing element and a flip-flop to register the logical “OR” gate output and provide it to the next to last processing element's “S-in” or intermediate result input. Each exponentiation controller 308, 318 provides operands and control signals to its associated Montgomery multiplier 310 and 320, respectively, and then receives the results of the performed Montgomery multiplication operation via the PE-0 of each multiplication chain after an appropriate number of clock cycles or “pulses”. The storage required for operands and results and the number of cycles or clocks between the beginning and completion of a Montgomery multiplication operation for an exponentiation controller is therefore dependent on the size or “length” of the Montgomery multiplication chain.

The first exponentiation controller 308 of the illustrated embodiment is a static 512-bit exponentiation controller while the second exponentiation controller 318 is selectable to operate as either a 512-bit exponentiation controller or as a 1024-bit exponentiation controller. In the illustrated embodiment, a Size Select control signal line 330 is utilized to select between a first, 512-bit mode of operation in which the first modular exponentiator 302 and the second modular exponentiator 304 are operably separated to operate as two independent 512-bit modular exponentiators, and a second, 1024-bit mode of operation in which the first modular exponentiator 302 and the second modular exponentiator 304 are operably coupled together to operate as a single 1024-bit modular exponentiator. The first and second operating modes are dynamically selectable in between individual modular exponentiation operations.

The Size Select control signal line 330 of the illustrated embodiment is utilized to select both the appropriate inputs for multiplexers 326 and 328 and the operating mode (512 or 1024-bit) of the second exponentiation controller 318. In an alternative embodiment, a control signal is supplied to the second exponentiation controller 318 which in turn generates one or more additional control signals to control coupling device 306 (e.g. to select the appropriate inputs of multiplexers 326 and 328). In the first, 512-bit mode, the first exponentiation controller 308 is coupled to the first group of processing elements 312 and the second group of processing elements 314 for its required total of 131 processing elements, and then to end logic 316. The second exponentiation controller 318, selected to operate as a 512-bit EC, is coupled to its own group of 131 processing elements 322, and then to end logic 324. No resources are wasted in this mode and the two exponentiation controllers 308, 318 can perform two separate 512-bit exponentiations independently of one another.

In the second, 1024-bit operating mode, the second exponentiation controller 318, selected to operate as a 1024-bit exponentiation controller, is coupled to the group of 131 processing elements 322, then via multiplexers 326 and 328 of coupling device 306 to the first group of 128 processing elements 314 for the required total of 259 processing elements, and finally to first end logic 316. The first exponentiation controller 308, the first group of processing elements 312, and second end logic 324 remain idle while modular exponentiator 300 is in this second, operably-coupled mode of operation. Since the Montgomery multiplication processing element chains represent the bulk of the logic however, only a trivial amount of logic is wasted in this configuration.

It should be appreciated that the number of processing elements utilized, the number of bits processed per element, and the size of the modular exponentiators shown are arbitrary and may be varied in alternative embodiments. For example, in one embodiment of the present invention, eight 256-bit modular exponentiators are selectively coupled together to provide a variety of modular exponentiator configurations or operating modes including: 1) eight 256-bit exponentiators; 2) four 512-bit exponentiators; 3) two 1024-bit exponentiators; 4) one 2048-bit exponentiator; 5) one 1024-bit exponentiator, one 512-bit exponentiator, and two 256-bit exponentiators; 6) two 768-bit exponentiators and one 512-bit exponentiator; or any other combination of various size exponentiators totaling 2048 total bits in multiples of 256. Thus, embodiments of the present invention allow modular exponentiation operations of various sizes to be performed quickly and efficiently in hardware.

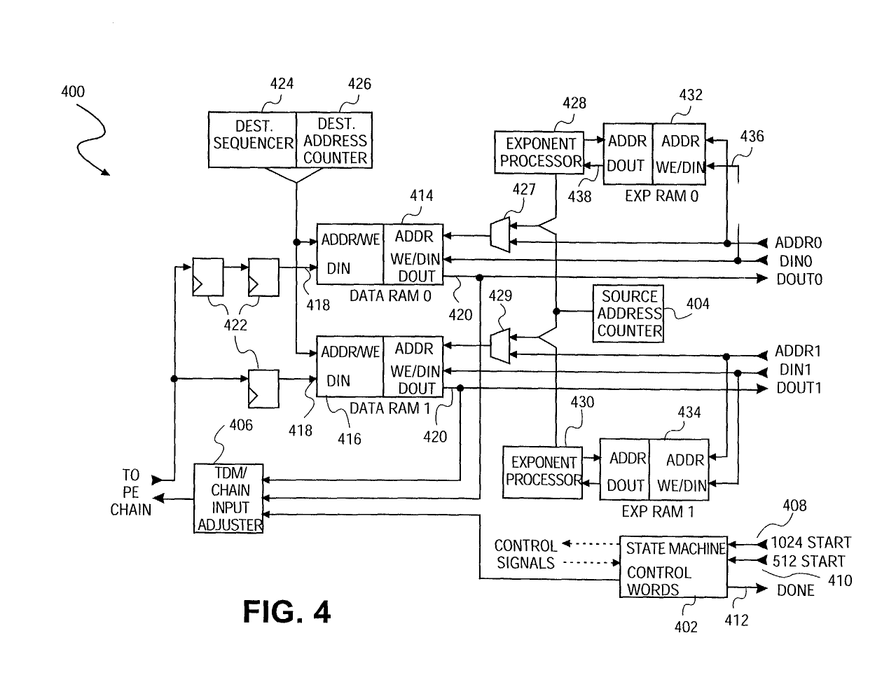

FIG. 4 illustrates a high-level block diagram of an exponentiation controller 400, such as second exponentiation controller 318 of FIG. 3, according to one embodiment of the present invention. Controller 400 of the illustrated embodiment includes a state machine 402, exponent RAM 0 423, exponent RAM 1 434, exponent processors 428 and 430, data RAM 0 414, data RAM 1 416, destination sequencer 424, destination address counter 426, and time division multiplexing(TDM)/chain input adjuster unit 406, as well as various registers 422 and multiplexers 427 and 429. State Machine 402 is responsible for generating the control words for one or more associated modular multiplier processing element chains and coordinating various tasks performed by the other components of the exponentiation controller 400.

In one embodiment, state machine 402, as well as the various RAMs (e.g. RAMs 414, 416, 432, and 434) of controller 400 operate based upon a received clock signal (not illustrated) having approximately half the frequency as a clock signal used to operate the processing elements of an associated modular multiplier. Accordingly, state machine 402 generates two sets of control words each clock cycle, and the TDM/chain input adjuster unit 406 alternates between the two. Utilizing these generated control words, state machine executes processing element chain functions such as grabbing input operand digits, calculating operand multiples, and performing Montgomery multiplication. One or more modular exponentiation operations are begun when a “start” input (e.g. 512 start input 410 or 1024 start input 408) is asserted and state machine 402 then asserts a done output 412 after the desired modular operations are complete. Which of the separate start inputs (408, 410) is asserted controls the operating mode (n-bit or 2 n-bit) of controller 402's associated modular exponentiator and its component parts.

Data RAM 0 414 and data RAM 1 416 store most of the necessary modular exponentiation data including in one embodiment, one or more base inputs, a Montgomery transformation factor ‘F’, a Montgomery transformed modulus, pre-calculated powers of each base, intermediate results, and the value 1 for inverse Montgomery transformation of a result. The total size of each data RAM 414, 416 depends on the size of controller 402 however, in the illustrated embodiment each data RAM 414, 416 includes storage for 4×10240 bits to accommodate up to 20 values, each 1028 bits long for either 512 or 1024-bit operands. Each of data RAM unit 414, 416 is dual-ported, including a “write” port 418 for writing results from and a “read” port 420 for feeding values to an associated modular multiplication computing chain.

Read ports 420 are also available for loading input data and retrieving results from outside controller 402. Address inputs are supplied to each of the read ports 420 via multiplexers 427 either directly from outside controller 402 when controller 402 is idle or by combining bits from source address counter 404 and the two exponent processors 428 and 430. In one embodiment, low address bits for read ports 420 are obtained from source address counter 404, whereas high bits are obtained from the two exponent processors 428 and 430. The addressed data RAM elements are then both provided to TDM/chain input adjuster unit 406, which generally alternates between the two.

Write ports 418 receive result data from the output an associated computing chain via one or two registers 422 utilized to line up the alternating data with the slower clock cycles with which the data RAMs are operated. Address inputs are supplied to each of the write ports 418 by combining bits from destination sequencer 424 and destination address counter 426. In one embodiment, destination sequencer 424 supplies the high five address bits to both data RAM write ports, selecting among the 20 available slots with the low address bits being supplied by destination address counter 426.

Destination address counter 426 selects 4-bit digits of data to be fed into an associated processing element chain by counting from digit 0 to either digit 130 or digit 258, depending on an operating mode (e.g. 512-bit or 1024-bit) of the controller 400 corresponding to which start signal 408 or 410 has been applied to state machine 402 at the beginning of a modular exponentiation operation. Destination address counter 426 waits for a signal from state machine 402 to begin writing results to each of the two data RAM write ports 418. When the signal is received, destination address counter asserts the write-enable signals of the write ports 418 and walks their lower address bits from zero to the appropriate target, thereafter dropping the write enable signals and resetting.

Exponent RAM 0 432 and 1 434 each comprise a dual-ported 4096-bit block RAM for storage of the two exponent values in the illustrated embodiment. A first port 436 is 4 bits wide, accessible outside of the controller 400 for loading new exponents. A second port 438 of the illustrated embodiment is 1 bit wide, and is utilized to feed a corresponding exponent processor 428 and 430 which addresses that port. Each exponent RAM 432, 434 is addressed utilizing a counter which starts at 511 or 1023, depending on an operating mode (e.g. 512-bit or 1024-bit) of the controller 400 corresponding to which start signal 408 or 410 has been applied to state machine 402 at the beginning of a modular exponentiation operation. It should be appreciated that the specific counter range values and the direction (e.g. up or down) in which the counting is accomplished throughout this description is arbitrary and not meant to limit the potential embodiments of the present invention. Exponent processors 428 and 430 are responsible for determining what computation is to be performed next.

In one embodiment, a 5-Ary exponentiation algorithm is implemented and Exponent processors 428 and 430 are utilized to determine whether to “square” or “multiply” in each multiplication cycle, and if multiplying, which of 16 stored powers to multiply by. Exponent processors 428 and 430 read stored exponent bits serially, although they may internally consider a window of 9 consecutive bits at any one time and provide the high 5 bits for addressing the read port 420 of the corresponding data RAM 414 or 416. In one embodiment, each exponent processor 428, 430 is also responsible for referencing the appropriate inputs during an initial transformation multiplication cycle and computing the 16 stored powers of the transformed base. Exponent processors 428 and 430 signal when their exponentiation operation is complete after referencing a stored “1” value in its corresponding data RAM for the inverse-transformation of the result.

Source address counter selects addresses to store 4-bit digits of data output from an associated processing element chain; by counting from digit 0 to either digit 128 or digit 256, depending on depending on an operating mode (e.g. 512-bit or 1024-bit) of the controller 400 corresponding to which start signal 408 or 410 has been applied to state machine 402 at the beginning of a modular exponentiation operation. Source address counter 404 receives a signal from state machine 402 signifying that new inputs are needed for the computing chain and then walks the low address bits for both data RAM read ports 420 from zero to the appropriate target. When a target address is reached, source address counter 404 then signals the state machine 402 to continue.

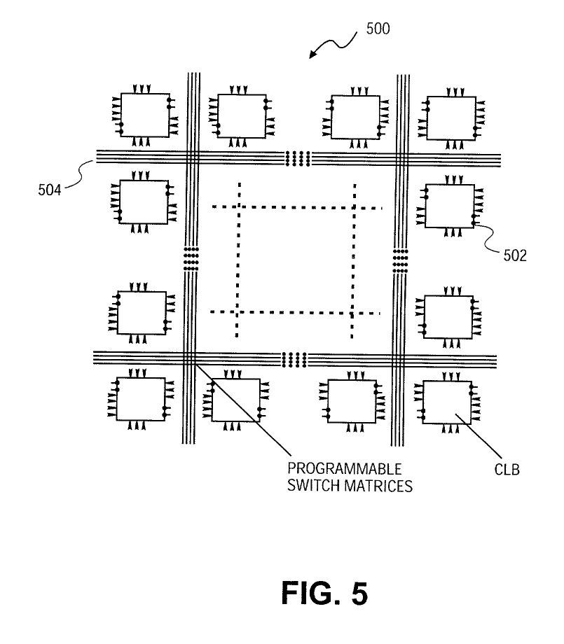

FIG. 5 illustrates a high-level block diagram of a field programmable gate array (FPGA) structure according to an embodiment of the present invention. In one embodiment of the present invention a Xilinx Virtex™ Series FPGA manufactured by Xilinx, Inc. of San Jose, Calif. is utilized to implement the present invention. Each FPGA includes a plurality of configurable logic blocks (CLBs) 502 coupled together utilizing routing resources such as programmable switch matrices 504. Elements of the processor or apparatus of the present invention are each constructed utilizing one or more configurable logic blocks and in a further embodiment are constructed such that CLBs associated with a given coupling device are adjacent to CLBs associated with one or more processing elements of each selectively coupled modular exponentiator. In yet another embodiment, CLBs for a given processing element are placed adjacent to the CLBs for its two neighboring PEs on the FPGA 500.

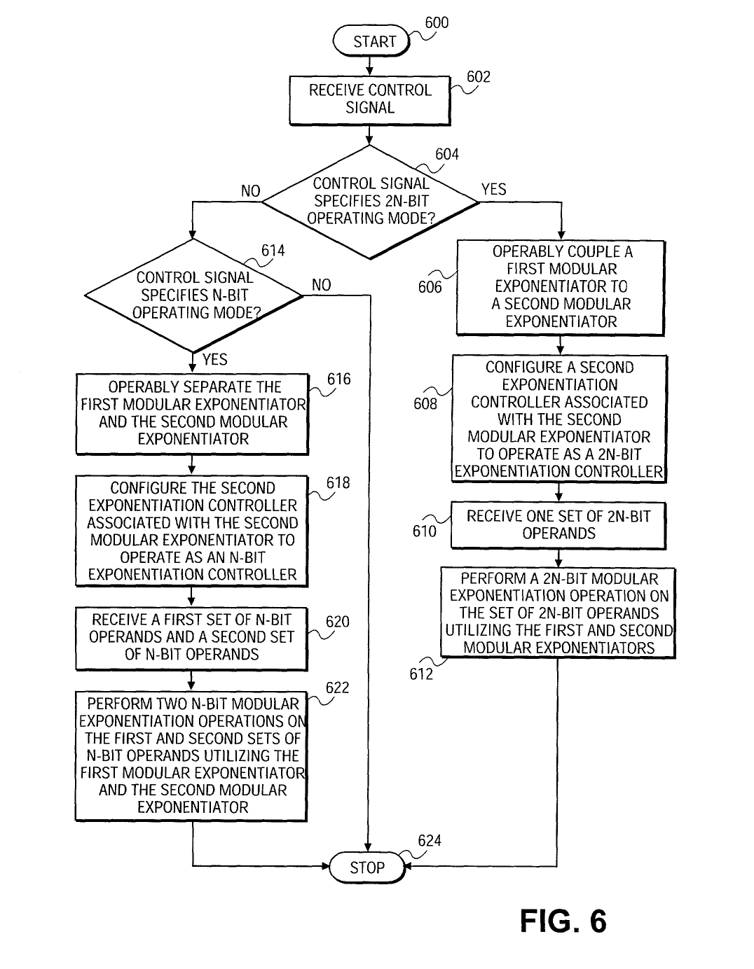

FIG. 6 illustrates a high-level process flow diagram for one embodiment of the method of the present invention. The process illustrated by FIG. 6 begins (block 600), and then a control signal such as the Size Select control signal of FIG. 3 is received (block 602). A determination is then made whether or not the received control signal specifies a 2 n-bit modular exponentiator operating mode (block 604). It should be appreciated that while the illustrated method embodiment relates to selection between n-bit and 2 n-bit modular exponentiation modes, the method of the present invention may be similarly utilized to selectively couple or combine modular exponentiators into any one of a variety of configurations. Accordingly, the determination whether or not the received control signal specifies a 2 n-bit modular exponentiator operating mode (block 604) may be varied and may be made in a variety of ways in alternative embodiments of the invention. For instance, the received control signal may comprise a plurality of binary bits specifying a plurality of operating modes. The plurality of bits may then be processed (e.g. decoded and compared or otherwise analyzed) to make the described determination.

If it is determined that the received control signal specifies a 2 n-bit operating mode, a first modular exponentiator is then operably coupled to a second modular exponentiator (block 606), a second exponentiation controller associated with the second modular exponentiator is configured to operate as a 2 n-bit exponentiation controller (block 608), a single set of 2 n-bit operands is received (block 610) and the operably coupled first and second modular exponentiators are utilized to perform a single, 2 n-bit modular exponentiation operation on the received set of 2 n-bit operands (block 612) before the process is concluded (block 624). It should be appreciated that the order in which the first and second modular exponentiators are coupled together (block 606), the second exponentiation controller is configured to operate in 2 n-bit mode (block 608), and the 2 n-bit operands are received (block 610) is arbitrary and shown for illustrative purposes only. In alternative embodiments of the present invention, these operations could therefore be performed in any order or substantially simultaneously.

If it is determined that the received control signal does not specify a 2 n-bit operating mode a determination is then made whether or not the received control signal specifies an n-bit mode of operation (block 614). It should similarly be appreciated that the order in which the determinations (blocks 604 and 614) and their subsequent associated operations (e.g. blocks 606-612 and 616-622) are performed is meant to be merely illustrative and is variable in alternative embodiments of the present invention. If it is determined that the received control signal does not specify an n-bit mode of operation, the illustrated process concludes (block 624). If a determination is made that the received control signal specifies an n-bit operating mode however, the first and second modular exponentiators are operably separated, the second exponentiation controller is configured to operate as an n-bit exponentiation controller, a first set and a second set of n-bit operands are received (block 620) and the first and second modular exponentiators are utilized to perform two n-bit modular exponentiation operations on the first and second sets of n-bit operands (block 622). Thereafter, the illustrated process concludes (block 624).

In the foregoing description, the present invention has been described with reference to specific exemplary embodiments thereof. It will be apparent however, that variations or modification of the exemplary embodiments described as well as alternative embodiments of the present invention may be implemented without departing from the broader spirit or scope of the present invention as defined in the appended claims. The specification and drawings are accordingly to be regarded in an illustrative rather than a restrictive sense.

What is claimed is:

1. An apparatus comprising:
a plurality of modular exponentiators including a first modular exponentiator and a second modular exponentiator; and
a coupling device interposed between said first modular exponentiator and said second modular exponentiator to receive a control signal and to selectively couple said first modular exponentiator to said second modular exponentiator in response to a state of said control signal.

2. The apparatus as set forth in claim 1, said apparatus having a first mode of operation corresponding to a first state of said control signal wherein said first modular exponentiator is operably separated from said second modular exponentiator and a second mode of operation corresponding to a second state of said control signal wherein said first modular exponentiator is operably coupled to said second modular exponentiator via said coupling device.

3. The apparatus as set forth in claim 2, wherein said first modular exponentiator and said second modular exponentiator operate as two n-bit modular exponentiators in said first mode of operation and as a single 2 n-bit modular exponentiator in said second mode of operation, where n is an integer.

4. The apparatus as set forth in claim 3, wherein n equals 512.

5. The apparatus as set forth in claim 1, wherein each of said plurality of modular exponentiators comprises a modular multiplier to perform a modular multiplication of the form A×B mod M, where A, B, and M are all integers.

6. The apparatus as set forth in claim 5, wherein said modular multiplier comprises a Montgomery multiplier.

7. The apparatus as set forth in claim 5, wherein said modular multiplier comprises a systolic array of processing elements.

8. The apparatus as set forth in claim 1, wherein said a coupling device comprises a multiplexer.

9. An apparatus comprising:
a plurality of modular multipliers including a first modular multiplier and a second modular multiplier;
a coupling device interposed between said first modular multiplier and said second modular multiplier to receive a control signal and to selectively couple said first modular multiplier to said second modular multiplier in response to a state of said control signal.

10. The apparatus as set forth in claim 9, said apparatus having a first mode of operation corresponding to a first state of said control signal wherein said first modular multiplier is operably separated from said second modular multiplier and a second mode of operation corresponding to a second state of said control signal wherein said first modular multiplier is operably coupled to said second modular multiplier via said coupling device.

11. The apparatus as set forth in claim 10, wherein said first modular multiplier and said second modular multiplier operate as two n-bit modular multipliers in said first mode of operation and as a single 2 n-bit modular multiplier in said second mode of operation, where n is an integer.

12. The apparatus as set forth in claim 11, wherein n equals 512.

13. The apparatus as set forth in claim 9, wherein each of said plurality of modular multipliers comprises a Montgomery multiplier.

14. The apparatus as set forth in claim 9, wherein each of said plurality of modular multipliers comprises a systolic array of processing elements.

15. The apparatus as set forth in claim 9, wherein said a coupling device comprises a multiplexer.

16. A processor comprising:
a plurality of modular exponentiators including a first modular exponentiator and a second modular exponentiator; and
a coupling device interposed between said first modular exponentiator and said second modular exponentiator to receive a control signal and to selectively couple said first modular exponentiator to said second modular exponentiator in response to a state of said control signal.

17. The processor as set forth in claim 16, said processor having a first mode of operation corresponding to a first state of said control signal wherein said first modular exponentiator is operably separated from said second modular exponentiator and a second mode of operation corresponding to a second state of said control signal wherein said first modular exponentiator is operably coupled to said second modular exponentiator via said coupling device.

18. The processor as set forth in claim 17, wherein said first modular exponentiator and said second modular exponentiator operate as two n-bit modular exponentiators in said first mode of operation and as a single 2 n-bit modular exponentiator in said second mode of operation, where n is an integer.

19. The processor as set forth in claim 18, wherein n equals 512.

20. The processor as set forth in claim 16, wherein said a coupling device comprises a multiplexer.

21. A system comprising:
a memory to store data and instructions;
a first processor coupled to said memory to process data and execute instructions; and
a second processor coupled to said memory, said second processor comprising:
a plurality of modular exponentiators including a first modular exponentiator and a second modular exponentiator; and
a coupling device interposed between said first modular exponentiator and said second modular exponentiator to receive a control signal and to selectively couple said first modular exponentiator to said second modular exponentiator in response to a state of said control signal.

22. The system as set forth in claim 21, said second processor having a first mode of operation corresponding to a first state of said control signal wherein said first modular exponentiator is operably separated from said second modular exponentiator and a second mode of operation corresponding to a second state of said control signal wherein said first modular exponentiator is operably coupled to said second modular exponentiator via said coupling device.

23. The system as set forth in claim 22, wherein said first modular exponentiator and said second modular exponentiator operate as two n-bit modular exponentiators in said first mode of operation and as a single 2 n-bit modular exponentiator in said second mode of operation, where n is an integer.

24. A method comprising:
receiving a control signal;
selectively coupling a first modular exponentiator to a second modular exponentiator of a plurality of modular exponentiators in response to a state of said control signal;
receiving a plurality of operands; and
performing a modular exponentiation operation on said plurality of operands utilizing said first modular exponentiator and said second modular exponentiator.

25. The method as set forth in claim 24, wherein selectively coupling a first modular exponentiator to a second modular exponentiator of a plurality of modular exponentiators in response to a state of said control signal comprises:
operably separating said first modular exponentiator from said second modular exponentiator in a first mode of operation corresponding to a first state of said control signal; and
operably coupling said first modular exponentiator to said second modular exponentiator in a second mode of operation corresponding to a second state of said control signal.

26. The method as set forth in claim 25, wherein performing a modular exponentiation operation on said plurality of operands utilizing said first modular exponentiator and said second modular exponentiator comprises:
operating said first modular exponentiator and said second modular exponentiator as two n-bit modular exponentiators in said first mode of operation and as a single 2 n-bit modular exponentiator in said second mode of operation, where n is an integer.

27. A machine-readable medium having a plurality of machine-executable instructions embodied therein which when executed by a machine, cause said machine to perform a method comprising:
receiving a control signal;
selectively coupling a first modular exponentiator to a second modular exponentiator of a plurality of modular exponentiators in response to a state of said control signal;
receiving a plurality of operands; and
performing a modular exponentiation operation on said plurality of operands utilizing said first modular exponentiator and said second modular exponentiator.

28. The machine-readable medium as set forth in claim 27, wherein selectively coupling a first modular exponentiator to a second modular exponentiator of a plurality of modular exponentiators in response to a state of said control signal comprises:
operably separating said first modular exponentiator from said second modular exponentiator in a first mode of operation corresponding to a first state of said control signal; and
operably coupling said first modular exponentiator to said second modular exponentiator in a second mode of operation corresponding to a second state of said control signal.

29. The machine-readable medium as set forth in claim 28, wherein performing a modular exponentiation operation on said plurality of operands utilizing said first modular exponentiator and said second modular exponentiator comprises:
operating said first modular exponentiator and said second modular exponentiator as two n-bit modular exponentiators in said first mode of operation and as a single 2 n-bit modular exponentiator in said second mode of operation, where n is an integer.
